(19) United States
(12) Patent Application Publication
(10) Pub. No.: US 2024/0378894 A1
(43) Pub. Date: Nov. 14, 2024

(54) LOADING ASSISTANCE APPARATUS, LOADING ASSISTANCE METHOD, AND NON-TRANSITORY STORAGE MEDIUM

(71) Applicant: NEC Corporation, Minato-ku, Tokyo (JP)

(72) Inventors: Yuma KAMIMOTO, Tokyo (JP); Daisuke KAWASAKI, Tokyo (JP); Kaori YAMANE, Tokyo (JP)

(73) Assignee: NEC Corporation, Minato-ku, Tokyo (JP)

(21) Appl. No.: 18/691,473

(22) PCT Filed: Sep. 29, 2021
(86) PCT No.: PCT/JP2021/035925

§ 371 Date: Mar. 13, 2024

(51) Int. Cl. G06V 20/52; G06Q 10/083

(52) U.S. Cl. CPC G06V 20/52; G06Q 10/083

(57) ABSTRACT

A loading assistance apparatus (109) includes a first acquiring unit (115) that acquires cargo information (114) relating to each of cargos (101_a) included in an unloaded cargo group, a second acquiring unit (116) that acquires loading information indicating a current loading status of a loading space, a deciding unit (117) that decides a cargo to be loaded next in the loading space, by using the cargo information and the loading information, and an output control unit (118) that causes a monitor (110) being a first output unit to output cargo specification information for specifying the cargo (101_a) to be loaded next.

### TECHNICAL FIELD

The present invention relates to a loading assistance apparatus, a loading assistance method, a loading assistance system, and a program.

### BACKGROUND ART

In order to improve transport efficiency in cargo transport, it is important to load more cargos onto a container, a cargo bed of a truck, or the like. For example, Patent Document 1 discloses a loading operation assistance system that specifies a position at which an object is to be loaded, for the object scheduled to be loaded in a predetermined space. With this, description that a filling rate of the predetermined space (loading space) for loading a cargo can be improved is in Patent Document 1.

### RELATED DOCUMENT

### Patent Document

Patent Document 1: International Patent Publication No. WO2020/009024

### DISCLOSURE OF THE INVENTION

### Technical Problem

For example, in general, at a base for trunk transport by a truck, a large volume of cargos collected from a predetermined area is sorted for each transport destination direction, and the cargo is subsequently carried to a transfer location near a truck parking position by a conveyor or the like. Then, the cargo transported to the transfer location is carried from the transfer location and loaded onto a cargo bed of a truck or the like, by an operator such as a driver.

During such a cargo loading operation, a cargo is carried to the transfer location one after another in some cases. Thus, it is desired to load the cargo at the transfer location onto a truck one after another as promptly as possible while considering a cargo loading rate of a cargo bed of a truck or the like.

However, even when one technique for improving a filling rate of a loading space can be provided by the technique described in Patent Document 1, it is difficult to improve efficiency of a loading operation including prompt loading of cargo at a transfer location onto a cargo bed of a truck.

The present invention has been made in view of the above-mentioned circumstances, and one object thereof is to improve efficiency of a cargo loading operation.

### Solution to Problem

In order to achieve the above-mentioned object, a loading assistance apparatus according to a first aspect of the present invention includes:
a first acquiring unit that acquires cargo information relating to each of cargos included in an unloaded cargo group;
a second acquiring unit that acquires loading information indicating a current loading status of a loading space;
a deciding unit that decides a cargo to be loaded next in the loading space, by using the cargo information and the loading information; and
an output control unit that causes a first output unit to output cargo specification information for specifying the cargo to be loaded next.

In order to achieve the above-mentioned object, a loading assistance system according to a second aspect of the present invention includes:
a first acquiring unit that acquires cargo information relating to each piece of cargos included in an unloaded cargo group;
a second acquiring unit that acquires loading information indicating a current loading status of a loading space;
a deciding unit that decides a cargo to be loaded next in the loading space, by using the cargo information and the loading information; and
a first output unit that outputs cargo specification information for specifying the cargo to be loaded next.

In order to achieve the above-mentioned object, a loading assistance method according to a third aspect of the present invention includes:
acquiring cargo information relating to each of cargos included in an unloaded cargo group;
acquiring loading information indicating a current loading status of a loading space;
deciding a cargo to be loaded next in the loading space, by using the cargo information and the loading information; and
causing a first output unit to output cargo specification information for specifying the cargo to be loaded next.

In order to achieve the above-mentioned object, a program according to a fourth aspect of the present invention causes a computer to execute:
acquiring cargo information relating to each of cargos included in an unloaded cargo group;
acquiring loading information indicating a current loading status of a loading space;
deciding a cargo to be loaded next in the loading space, by using the cargo information and the loading information; and
causing a first output unit to output cargo specification information for specifying the cargo to be loaded next.

### Advantageous Effects of Invention

According to the present invention, it is possible to improve efficiency of a cargo loading operation.

### BRIEF DESCRIPTION OF THE DRAWINGS

FIG. 1 is a diagram illustrating a configuration of a loading assistance system according to a first example embodiment of the present invention.

FIG. 2 is a diagram illustrating a functional configuration of a cargo management apparatus according to the first example embodiment.

FIG. 3 is a diagram illustrating one example of a configuration of cargo information according to the first example embodiment.

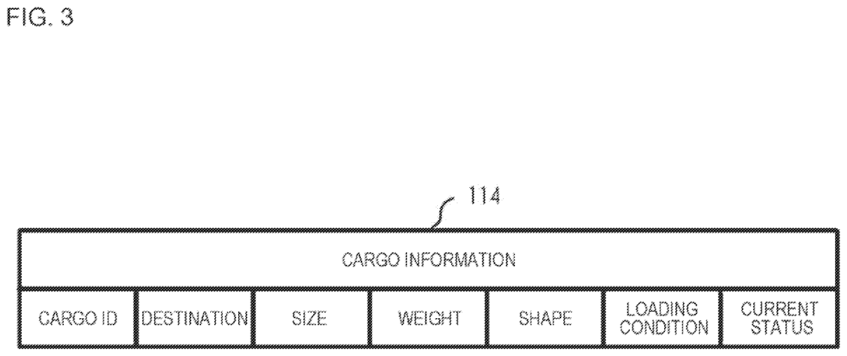

FIG. 4 is a diagram illustrating a functional configuration of a loading assistance apparatus according to the first example embodiment.

FIG. 5 is a diagram illustrating a physical configuration of the loading assistance apparatus according to the first example embodiment.

FIG. 6 is a flowchart illustrating one example of loading assistance processing according to the first example embodiment of the present invention.

FIG. 7 is a flowchart illustrating one example of the loading assistance processing according to the first example embodiment of the present invention.

FIG. 8 is a diagram illustrating a configuration of a loading assistance system according to a second modification example.

FIG. 9 is a diagram illustrating a physical configuration of a display apparatus according to the second modification example.

FIG. 10 is a flowchart illustrating one example of loading assistance processing according to the second modification example.

FIG. 11 is a diagram illustrating a configuration of a loading assistance system according to a second example embodiment of the present invention.

FIG. 12 is a diagram illustrating a functional configuration of a cargo management apparatus according to the second example embodiment.

FIG. 13 is a diagram illustrating one example of a configuration of cargo information according to the second example embodiment.

FIG. 14 is a diagram illustrating a functional configuration of a loading assistance apparatus according to the second example embodiment.

FIG. 15 is a flowchart illustrating one example of loading assistance processing according to the second example embodiment of the present invention.

### DESCRIPTION OF EMBODIMENTS

Example embodiments of the present invention are described below with reference to the drawings. Note that, in all the drawings, a similar constituent element is denoted with a similar reference sign, and description therefor is omitted as appropriate.

### First Example Embodiment

### <Configuration of Loading Assistance System 100>

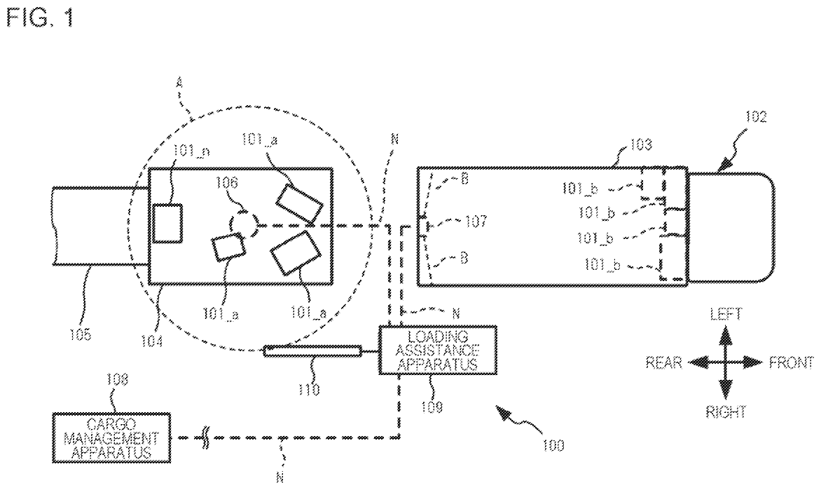

A loading assistance system 100 according to a first example embodiment of the present invention is a system for assisting a loading operation for loading a cargo 101 in a loading space, as illustrated in FIG. 1.

The cargo 101 is an object to be loaded in the loading space. The loading space is a predetermined space, and is an enclosed space such as a cargo bed 103 of a truck 102, a container, and a warehouse.

The present example embodiment is described with an example in which the loading space is provided to the cargo bed 103 of the truck 102 for trunk transport. In general trunk transport, the cargo 101 in a predetermined area is collected at a base, and a large volume of cargo is collectively transported from the base to a different base.

At the base, the cargo 101 collected for an associated area is sorted for each of different bases being transport destinations (hereinafter, also referred to as a “transport direction”), and is carried by a conveyor 105 or the like to a transfer location 104. The truck 102 is parked at a predetermined parking position on a front side of the transfer location 104 while a rear side of the cargo bed 103 is opened. Note that, in FIG. 1, a door for opening and closing the rear side of the cargo bed 103 is not illustrated.

The cargo 101 transferred to the transfer location 104 is loaded in the loading space from the rear side of the cargo bed 103 by an operator such as a driver of the truck 102. During such a loading operation, the cargo 101 is carried to the transfer location 104 one after another, and hence a plurality of the cargo 101 that are unloaded onto the cargo bed 103 are frequently accumulated as illustrated in FIG. 1.

In the following description, when making a distinction regarding whether the cargo 101 is loaded onto the cargo bed 103 (the loading space), the cargo 101 unloaded onto the cargo bed 103 (the loading space) is also referred to as a “cargo 101a”, as illustrated in FIG. 1. Further, the cargo 101 loaded onto the cargo bed 103 (the loading space) is also referred to as a “cargo 101_b”.

Moreover, the cargo 101 of the unloaded cargo 101, which is newly carried to the transfer location 104 by the conveyor 105 or the like, is also referred to as a “cargo 101_n”. Further, the unloaded cargo 101 is collectively referred to as a term “unloaded cargo group”. In other words, the unloaded cargo group consists of the unloaded cargo 101 (the cargo 101a), and the unloaded cargo 101 (the cargo 101a) includes the cargo 101 (the cargo 101n) to be added to the unloaded cargo 101. Note that, the number of the cargo 101 constituting the unloaded cargo group may be one.

As illustrated in FIG. 1, the loading assistance system 100 includes a first imaging unit 106, a second imaging unit 107, a cargo management apparatus 108, a loading assistance apparatus 109, and a monitor 110 connected to the loading assistance apparatus 109 via a wiring line.

Each of the first imaging unit 106, the second imaging unit 107, and the cargo management apparatus 108 is connected to the loading assistance apparatus 109 in such a way as to be able to transmit and receive information mutually with the loading assistance apparatus 109 via a network N. The network N may be constructed by a wired line, a wireless line, or a combination of these lines as appropriate. For example, the network N according to the present example embodiment is a local area network (LAN) provided to the base for trunk transport.

Note that, the monitor 110 may be connected to the loading assistance apparatus 109 via the network N by being connected to another not-illustrated apparatus or being included integrally with an apparatus such as a tablet terminal.

The first imaging unit 106 captures an image of the transfer location 104, and generates first image data including the captured image.

As illustrated in FIG. 1, the first imaging unit 106 according to the present example embodiment is installed on a ceiling directly above substantially the center of the transfer location 104, and captures an image of a region surrounded by a dot-line circle A illustrated in FIG. 1. With this, the first imaging unit 106 captures an image of the entire transfer location 104, and generates the first image data including an image of the cargo 101_a included in the unloaded cargo group.

The second imaging unit 107 is an imaging apparatus that captures an image of the loading space inside the cargo bed 103 and generates second image data including the captured image.

The second imaging unit 107 according to the present example embodiment is installed at the center of a rear end of the ceiling of the cargo bed 103, for example. The second imaging unit 107 is installed in such a way as to capture an image of a lower-front region with respect to an installation position (a region sandwiched between two dot-lines B illustrated in FIG. 1 as viewed from above). With this, the second imaging unit 107 captures an image of substantially the entirety of the loading space, and generates the second image data including an image of the loaded cargo 101_b.

### (Functional Configuration of Cargo Management Apparatus 108)

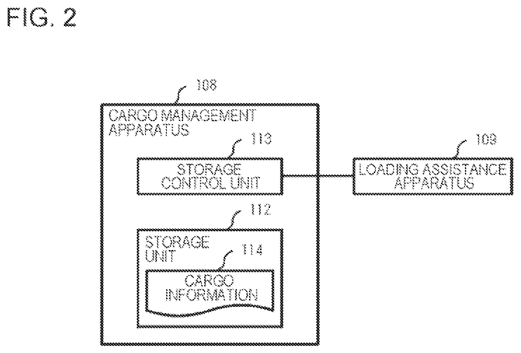

The cargo management apparatus 108 is an apparatus for managing the cargo 101 transported by trunk transport. As illustrated in FIG. 2, the cargo management apparatus 108 includes a storage unit 112 and a storage control unit 113 in a functional sense.

The storage unit 112 stores various types of information such as cargo information 114.

The cargo information 114 is information relating to the cargo 101. For example, as illustrated in FIG. 2, the cargo information 114 is information associated with a “cargo identification (ID)”, a “destination”, a “transport direction”, a “size”, “weight”, a “shape”, a “loading condition”, a “current status”, and the like.

The “cargo ID” is information for identifying each of the cargos 101.

The “destination” is information indicating a destination of the cargo 101 identified by the cargo ID being associated therewith. An address is set to the “destination”, for example.

The “transport direction” is information indicating a transport direction of the cargo 101 identified by the cargo ID being associated therewith. Information for determining a base being a transport destination of trunk transport is set to the “transport direction”, for example.

Note that, the transport direction may be determined based on the destination, and the cargo information 114 in this case may not include the “transport direction”.

The “size” is information indicating a size of the cargo 101 identified by the cargo ID being associated therewith, and includes a length of each of vertical, horizontal, and height directions (in other words, dimensions), for example.

The “weight” is information indicating weight of the cargo 101 identified by the cargo ID being associated therewith.

The “shape” is information indicating a shape of the cargo 101 identified by the cargo ID being associated therewith. “Rectangular parallelepiped”, “columnar”, “others”, and the like are set to the “shape”. Herein, “rectangular parallelepiped” and “columnar” are examples of information indicating a predetermined specific shape. “Others” is information indicating a shape other than the predetermined specific shape.

Further, for example, in a case of some cargos 101 such as a “golf bag”, the shape can be determined roughly, based on a content of the cargo 101. In such a case, the “golf bag” may be set to the “shape” indicated in the cargo information 114 as “information indicating the predetermined specific shape”.

The “loading condition” is information indicating a condition regarding loading of the cargo 101 identified by the cargo ID being associated therewith. For example, the “loading condition” may including a handling condition relating to handling of the cargo 101, such as “this side up”. Further, for example, “the loading condition” may include an attribute of the cargo 101 such as a fragile item and delicate machinery. Herein, the term “fragile item” indicates a characteristic of prone to breakage, such as the cargo 101 of a ceramic and a glass item.

The “current status” is information indicating a current status of the cargo 101 identified by the cargo ID being associated therewith. For example, “sorting in progress”, “unloaded”, “loaded”, and “shipped” are set to the “current status”.

“Sorting in progress” is information indicating a status from arrival of the cargo 101 at the base to the arrival thereof at the transfer location 104 in the transport direction associated with the destination.

“Unloaded” is information indicating a status in which loading onto the cargo bed 103 (the loading space) is not performed after the arrival at the transfer location 104.

“Loaded” is information indicating a status in which the truck 102 does not yet depart after loading onto the cargo bed 103 (the loading space) of the truck 102 (in other words, an operation for loading the cargo 101 is in progress in the truck 102).

“Shipped” is information indicating a status in which the truck 102 onto which the cargo 101 is loaded departs from a parking position in a vicinity of the transfer location 104.

Refer back to FIG. 2.

The storage control unit 113 controls the storage unit 112. Further, the storage control unit 113 communicates with the loading assistance apparatus 109 via the network N.

In the present example embodiment, the storage control unit 113 transmits the cargo information 114 according to information being acquired from the loading assistance apparatus 109 via the network N. Further, the storage control unit 113 updates the “current status” in the cargo information 114 according to information being acquired from the loading assistance apparatus 109 via the network N.

### (Functional Configuration of Loading Assistance Apparatus 109)

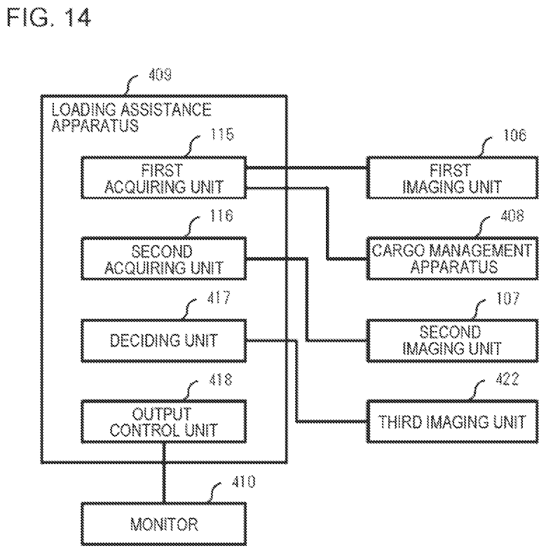

The loading assistance apparatus 109 is an apparatus for assisting a loading operation for loading the cargo 101 in the loading space. For example, the loading assistance apparatus 109 is provided in association with each transport direction. As illustrated in FIG. 14, the loading assistance apparatus 109 functionally includes a first acquiring unit 115, a second acquiring unit 116, a deciding unit 117, and an output control unit 118.

The first acquiring unit 115 acquires the cargo information 114 relating to each of a plurality of the cargos 101a included in the unloaded cargo group.

The first acquiring unit 115 according to the present example embodiment acquires the first image data from the first imaging unit 106 in real time. The first acquiring unit 115 determines an image of each of the unloaded cargos 101_a, based on the first image data. The first acquiring unit 115 acquires the cargo information 114 relating to each of the cargos 101_a determined from the first image data by communicating with the cargo management apparatus 108, and stores the acquired cargo information 114.

Note that, the cargo information 114 acquired by the first acquiring unit 115 is only required to include at least one of the size, the weight, the shape, and the loading condition of the cargo 101a.

The second acquiring unit 116 acquires loading information indicating a current loading status of the loading space.

The second acquiring unit 116 according to the present example embodiment acquires the second image data from the second imaging unit 107 in real time. The second acquiring unit 116 determines an image of each of the loaded cargos 101_b, based on the second image data. With this, the second acquiring unit 116 acquires the loading information.

The deciding unit 117 decides a cargo 101_a to be loaded next in the loading space and a loading position of the cargo 101a, by using the cargo information and the loading information. The loading position of the cargo 101_a is a position at which the cargo 101_a is loaded in the loading space.

The output control unit 118 causes the monitor 110 to output cargo specification information for specifying the cargo 101_a to be loaded next and position specification information for specifying the loading position of the cargo 101_a to be loaded next.

Refer back to FIG. 1.

The monitor 110 is an apparatus that displays an image under control of the output control unit 118. The monitor 110 may be provided in such a way as to allow an operator to browse at a time of performing a loading operation.

The monitor 110 according to the present example embodiment displays the cargo specification information and the position specification information. In other words, In the present example embodiment, a first output unit that outputs the cargo specification information and a second output unit that outputs the position specification information are achieved by one monitor 110. For example, the cargo specification information and the position specification information may be displayed separately in different regions acquired by dividing a display region of the monitor 110. Note that, the cargo specification information and the position specification information may be displayed alternatingly at a predetermined time interval on the monitor 110.

The functional configuration of the loading assistance system 100 according to the first example embodiment is mainly described above. A physical configuration of the loading assistance system 100 is described below.

### (Physical Configurations of First Imaging Unit 106 and Second Imaging Unit 107)

Each of the first imaging unit 106 and the second imaging unit 107 is achieved by a camera including an imaging element, for example. Each of the first imaging unit 106 and the second imaging unit 107 is preferably a 3D camera capable of also acquiring information (depth upward) relating to a depth direction. An imaging method of the 3D camera may adopt a related-art technique.

### (Physical Configuration of Cargo Management Apparatus 108)

The cargo management apparatus 108 may be configured substantially similarly to the loading assistance apparatus 109 in a physical sense. Thus, the physical configuration of the loading assistance apparatus 109 is first described with reference to the drawing, and thereafter, the physical configuration of the cargo management apparatus 108 is described with a different point from the physical configuration of the loading assistance apparatus 109.

### (Physical Configuration of Loading Assistance Apparatus 109)

For example, the loading assistance apparatus 109 is a general purpose computer or the like in a physical sense.

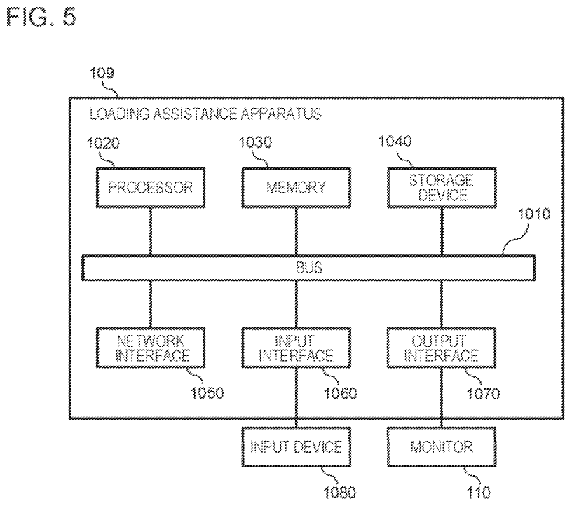

Specifically, for example, as illustrated in FIG. 5, the loading assistance apparatus 109 physically includes a bus 1010, a processor 1020, a memory 1030, a storage device 1040, a network interface 1050, an input interface 1060, and an output interface 1070.

The bus 1010 is a data transmission path in which the processor 1020, the memory 1030, the storage device 1040, the network interface 1050, the input interface 1060, and the output interface 1070 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a memory card, a read only memory (ROM), or the like. The storage device 1040 stores a program module for achieving each of the function units of the loading assistance apparatus 109. The processor 1020 reads each of the program modules on the memory 1030 and executes the program module, and thereby each of the function units associated with each of the program modules is achieved.

The network interface 1050 is an interface for connecting the loading assistance apparatus 109 to the network N.

An input device 1080 such as a keyboard and a mouse for inputting information from an operator being as a user is connected to the input interface 1060.

The monitor 110 for outputting information to an operator being as a user is connected to the output interface 1070. Examples of the monitor 110 include a liquid crystal display panel, an organic electro-luminescence (EL) monitor, and the like.

The cargo management apparatus 108 is different from the loading assistance apparatus 109 in that the storage device 1040 stores the program module for achieving each of the function units of the cargo management apparatus 108. Further, a difference from the loading assistance apparatus 109 is that the network interface 1050 connects the cargo management apparatus 108 to the network N. Except for those matters, the physical configuration of the cargo management apparatus 108 is substantially similar to the physical configuration of the loading assistance apparatus 109 described above.

The configuration of the loading assistance system 100 according to the first example embodiment of the present invention is described above. An operation of the loading assistance system 100 according to the present example embodiment is described below.

### <Operation of Loading Assistance System 100>

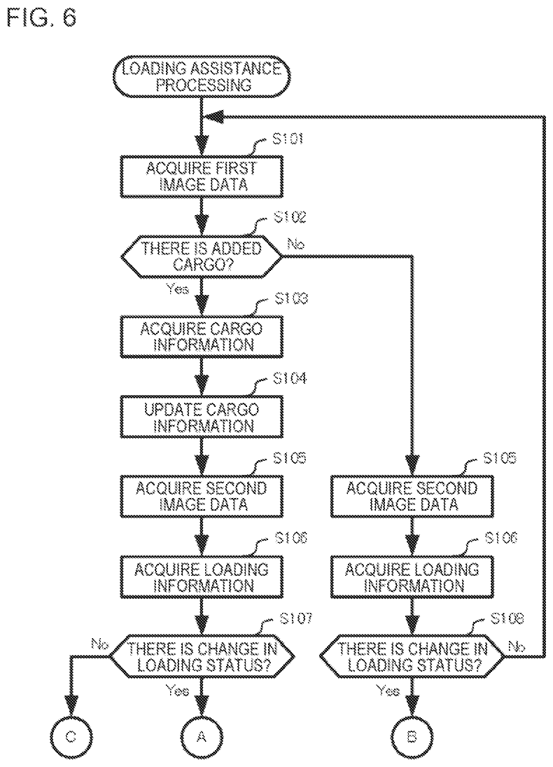

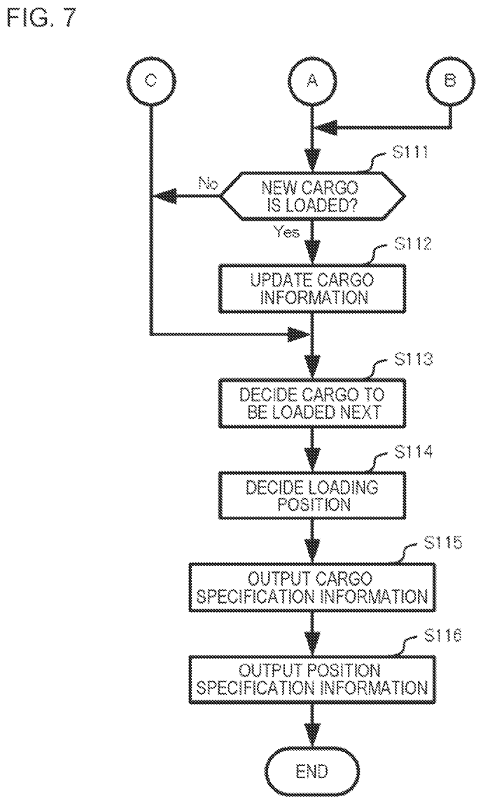

Each of FIGS. 6 and 7 is a flowchart illustrating one example of loading assistance processing according to the present example embodiment. The loading assistance processing is processing for assisting a loading operation for loading the cargo 101 in the loading space.

For example, the loading assistance processing is started by operating the first imaging unit 106, the second imaging unit 107, the cargo management apparatus 108, the loading assistance apparatus 109, and the monitor 110. Further, during the operations of these, the loading assistance processing is executed repeatedly.

During the operation, the first imaging unit 106 continuously outputs the first image data. Similarly, during the operation, the second imaging unit 107 continuously outputs the second image data. With this, the loading assistance apparatus 109 can acquire the first image data indicating a current status of the transfer location 104 and the second image data indicating a current status of the loading space in real time.

Refer to FIG. 6.

The first acquiring unit 115 acquires first image data from the first imaging unit 106 in real time (step S101).

The first acquiring unit 115 stores the first image data acquired in step S101, and decides whether there is the cargo 101_n being added to the unloaded cargo 101_a, based on the first image data (step S102).

Specifically, the first acquiring unit 115 compares the first image data acquired in current step S101 and first image data acquired in previous step S101 with each other. Further, the first acquiring unit 115 determines the cargo 101_a included in each piece of the first image data by subjecting each piece of the first image data to perform image processing.

When a cargo 101_a not being included in the first image data acquired in previous step S101 is included in the first image data acquired in current step S101, the first acquiring unit 115 decides that there is the added cargo 101_n. In other cases, the first acquiring unit 115 decides that there is not the added cargo 101_n.

Note that, in step S102, a method of deciding whether there is the added cargo 101_n is not limited thereto. For example, when the transfer location 104 is provided with a weight sensor (not illustrated), and weight of the cargo 101_a at the transfer location 104 is changed, specifically, for example, when the weight of the cargo 101_a at the transfer location 104 is increased, the first acquiring unit 115 may decide that there is the added cargo 101_n. Further, for example, when a cargo sensor (for example, a not-illustrated sensor, such as an infrared sensor) for detecting passage of the cargo 101_n through a predetermined position (for example, an exit of the conveyor 105, an entrance of the transfer location 104, or the like) is provided, and the cargo sensor detects passage of the cargo 101_n through the position, the first acquiring unit 115 may decide that there is the added cargo 101_n. Moreover, for example, when passage of the cargo 101_n through the above-mentioned position is detected by executing image processing using the first image data, the first acquiring unit 115 may decide that there is the added cargo 101_n.

When it is decided that there is the added cargo 101_n (step S102; Yes), the first acquiring unit 115 acquires the cargo information 114 relating to the added cargo 101_n (step S103).

Appropriate methods may be adopted as a method of acquiring the cargo information 114 in step S103. Herein, as examples, first to third methods of acquiring the cargo information 114 are described below.

(First Method of acquiring Cargo Information 114)

The first acquiring unit 115 acquires, from the cargo management apparatus 108, the cargo information 114 associated with the cargo 101_n being decided to be added to the unloaded cargo group in step S102, based on the first image data.

Specifically, for example, the first acquiring unit 115 determines a shape and a size of the cargo 101_n from the first image data. A related-art technique may be adopted to determine the shape and the size of the cargo 101_n from the first image data. The first acquiring unit 115 transmits an inquiry including the shape and the size that are determined, to the cargo management apparatus 108.

The storage control unit 113 first executes extraction processing of the cargo information 114, based on the “current status” and the “transport direction”. Specifically, for example, the storage control unit 113 extracts the cargo information 114 including the “transport direction” associated with the loading assistance apparatus 109 including the first acquiring unit 115 that transmits the inquiry, from the cargo information 114 in which the “current status” is “sorting in progress”.

Subsequently, the storage control unit 113 executes determination processing of the cargo information 114, based on the shape and the size that are included in the inquiry. Specifically, for example the storage control unit 113 determines the cargo information 114 associated with the “shape” and the “size” that match with the shape and the size included in the inquiry, respectively, from the extracted cargo information 114.

Herein, in the determination processing of the cargo information 114, the cargo information 114 associated with the “shape” and the “size” that are same as the shape and the size included in the inquiry, respectively, is preferably determined.

However, even in a case of the same cargo 101_n, the size included in the inquiry and the “size” in the cargo information 114 may be different from each other due to a measurement error or the like in image processing.

Thus, for example, the “size” closest to the size included in the inquiry may be decided as a match to the size included in the inquiry. Further, for example, the “size” in the cargo information 114, which is closest to the size included in the inquiry and has a size difference falling within a predetermined range, may be decided as a match to the size included in the inquiry.

Further, even in a case of the same cargo 101n, the shape included in the inquiry and the “shape” in the cargo information 114 may be different from each other due to an error in shape or the like recognized by image processing.

Thus, for example, in consideration of an error in shape or the like recognized by image processing, a match shape combination between the shape included in the inquiry and the “shape” in the cargo information 114 may be set in advance, and stored in the storage control unit 113. Further, when the shape included in the inquiry and the “shape” in the cargo information 114 match with a predetermined combination, the “shape” in the cargo information 114 may be decided as a match to the shape included in the inquiry.

Further, the storage control unit 113 transmits the determined cargo information 114 to the loading assistance apparatus 109. With this, the first acquiring unit 115 acquires the cargo information 114 relating to the added cargo 101_n.

Note that, when it is not possible to determine the cargo information 114 associated with the “shape” and the “size” that match with the shape and the size included in the inquiry, respectively, the storage control unit 113 may transmit error information to the loading assistance apparatus 109. The error information is information indicating that there is no cargo information 114 matching with the shape and the size that are determined from the first image data. The error information may be displayed by the monitor 110 as described later.

(Second Method of acquiring Cargo Information 114)

In the first method of acquiring the cargo information 114, description is made on an example in which the storage control unit 113 executes the extraction processing and the determination processing of the cargo information 114. However, the first acquiring unit 115 may acquire the cargo information 114 from the cargo management apparatus 108, and execute the extraction processing and the determination processing of the cargo information 114. Alternatively, the first acquiring unit 115 may acquire, from the cargo management apparatus 108, the cargo information 114 extracted by the extraction processing of the cargo information 114, and execute the determination processing of the cargo information 114.

(Third Method of acquiring Cargo Information 114)

The first acquiring unit 115 may acquire the cargo information 114 relating to the unloaded cargo 101_n by generating the cargo information 114 relating to the added cargo 101_n, based on the first image data. In this case, there is no need to refer to the cargo information 114, and hence the cargo management apparatus 108 is not required to be included in the loading assistance system 100.

The “cargo ID” may be applied by the first acquiring unit 115 by the first acquiring unit 115.

In general, a destination label adheres to an outer surface of the cargo 101. The “destination” may be set based on an image of the destination label. For example, the image of the destination label may be set to the “destination”. Further, for example, information such as a character indicating the destination may be acquired by subjecting the image of the destination label to image processing, and the acquired information may be set to the “destination”.

The “size” may be determined from the first image data and set. As described above, a related-art technique may be adopted to determine the size of the cargo 101_n from the first image data.

Through connection with a weight sensor (not illustrated) provided to the transfer location 104, the “weight” may be acquired from the weight sensor and set to the cargo information 114.

The “shape” may be determined from the first image data. As described above, a related-art technique may be adopted to determine the shape of the cargo 101_n from the first image data.

In general, a loading condition label including characters such as “this side up”, “a fragile item”, and “delicate machinery”, pictures indicating those conditions, or the like may adhere to the outer surface of the cargo 101. The “loading condition” may be set based on an image of the loading condition label. For example, the “loading condition” may acquire information indicating the loading condition by subjecting the image of the loading condition label to image processing, and the acquired information may be set to the “loading condition”.

“Unloaded” may be set to the “current status”.

In this manner, when the first acquiring unit 115 acquires information to be set for each element constituting the cargo information 114, based on the first image data, each piece of the acquired information is associated with each other. With this, the first acquiring unit 115 can generate the cargo information 114 relating to the cargo 101_n.

The examples of the method of acquiring the cargo information 114 are described above.

Refer back to FIG. 6 again.

The first acquiring unit 115 stores the cargo information 114 acquired in step S103, and also transmits an instruction of changing the “current status” in the cargo information 114 to the cargo management apparatus 108. With this, the first acquiring unit 115 updates the cargo information 114 relating to the unloaded cargo 101a (step S104).

Specifically, for example, the first acquiring unit 115 can store the cargo information 114 relating to the unloaded cargo 101_a by storing the cargo information 114 acquired in step S103. Further, the first acquiring unit 115 transmits an instruction of setting “unloaded” to the “current status” in the cargo information 114 acquired in step S103. With this, the “current status” in the cargo information 114 relating to the cargo 101_n being stored in the storage unit 112 is changed from “sorting in progress” to “unloaded”.

The second acquiring unit 116 acquires second image data from the second imaging unit 107 in real time (step S105).

The second acquiring unit 116 acquires the loading information indicating a current loading status of the loading space, based on the second image data acquired in step S105 (step S106). Further, the second acquiring unit 116 stores the acquired loading information.

The second acquiring unit 116 stores the loading information acquired in step S106, and decides whether there is a change in the loading status, based on the loading information (step S107).

Specifically, for example, the second acquiring unit 116 compares the loading information acquired in current step S106 and the loading information acquired in previous step S106 with each other. With this, the second acquiring unit 116 decides whether there is a change in the cargo 101_b determined from each piece of the loading information.

As a case where there is a change in the loaded cargo 101_b, for example, there is a case where a new cargo 101 is loaded onto the cargo bed 103 (the loading space), a case where the loading position of the loaded cargo 101_b is changed by an operator, or the like.

When it is decided that there is not the added cargo 101_n (step S102; Yes), the second acquiring unit 116 executes processing similar to steps S105 and S106 described above.

The second acquiring unit 116 stores the loading information acquired in step S106, and decides whether there is a change in the loading status, based on the loading information (step S108).

In step S108, it is also decided whether there is a change in the loading status, based on the loading information, by a method similar to that in step S107.

When it is decided that there is not a change in the loading status, (step S108; No), the processing after step S101 is repeated again.

As illustrated in FIG. 7, when it is decided that there is a change in the loading status (step S107; Yes, or step S108; Yes), the second acquiring unit 116 decides whether a new cargo 101_b is loaded (step S111). In other words, it is decided whether the cargo 101 is added to the loaded cargo 101_b.

Specifically, for example, when the cargo 101_b not being included in the loading information previously acquired in step S106 relating to a current loading operation onto the cargo bed 103 is included in the loading information acquired in current step S106, the second acquiring unit 116 decides that the new cargo 101_b is loaded. In other cases, the second acquiring unit 116 decides that the new cargo 101_b is not loaded.

When it is decided that the new cargo 101 is loaded (step S111; Yes), the second acquiring unit 116 removes the cargo information 114 relating to the newly-loaded cargo 101_b from the cargo information 114 stored in the first acquiring unit 115. Further, the second acquiring unit 116 transmits an instruction of changing the “current status” in the cargo information 114 relating to the newly-loaded cargo 101_b to the cargo management apparatus 108. With this, the second acquiring unit 116 updates the cargo information 114 relating to the newly-loaded cargo 101_b (step S112).

Specifically, the second acquiring unit 116 determines a dimension and a shape of the newly-loaded cargo 101_b, based on the second image data.

Further, the second acquiring unit 116 removes the cargo information 114 associated with the “shape” and the “size” that match with the determined dimension and shape, from the cargo information 114 stored in the first acquiring unit 115. With this, the first acquiring unit 115 can store the cargo information 114 relating to the unloaded cargo 101_a.

Further, the second acquiring unit 116 transmits an instruction of setting “loaded” to the “current status” in the cargo information 114 associated with the “shape” and the “size” that match with the determined dimension and shape.

More specifically, from the cargo information 114 in which the “current status” is “unloaded”, the storage control unit 113 extracts the cargo information 114 including the “transport direction” associated with the loading assistance apparatus 109 including the second acquiring unit 116 transmitting the instruction. Further, from the extracted cargo information 114, the storage control unit 113 determines the cargo information 114 associated with the “shape” and the “size” that match with the shape and the size included in the instruction, respectively. The storage control unit 113 sets “loaded” to the “current status” in the determined cargo information 114. With this, the “current status” in the cargo information 114 relating to the newly-loaded cargo 101_b is changed from “unloaded” to “loaded”.

Herein, for example, as a method of determining ‘the cargo information 114 associated with the “shape” and the “size” that match with the determined dimension and shape’, a method similar to the above-mentioned determination processing of the cargo information 114 may be adopted.

The deciding unit 117 decides the cargo 101a to be loaded next onto the cargo bed 103 (the loading space), based on the cargo information 114 relating to the unloaded cargo 101a and the loading information acquired in step S106 (step S113).

The current cargo information 114 relating to the unloaded cargo 101_a is stored in the first acquiring unit 115, and hence the deciding unit 117 may acquire the cargo information 114 relating to the unloaded cargo 101a from the first acquiring unit 115.

Further, the deciding unit 117 decides a loading position of the cargo 101_a decided in step S113 (step S114).

The cargo 101_a to be loaded next and the loading position thereof are decided in steps S113 to S114 by using a learning model being learnt through machine learning, for example. In other words, the deciding unit 117 inputs the cargo information 114 relating to each of the cargos 101_a in the unloaded cargo group to a leaning model for deciding the cargo 101_a to be loaded next and the loading position thereof, the learning model being learnt through machine learning, and thus decides the cargo 101_a to be loaded next and the loading position thereof.

Data input to the learning model during learning are the cargo information 114 relating to each of the plurality of the cargos 101. Further, during machine learning, there may be performed supervised learning where the cargo 101_a to be loaded next and the loading position thereof that are decided by an operator skilled in a loading operation are correct answers, according to the cargo information 114 relating to each of the plurality of the cargos 101.

In general, loading efficiency varies depending on a skill level of an operator, and a more skillful operator can load cargo in a loading space at higher loading rate in most cases. Therefore, through supervised learning where a decision content of an operator skilled in a loading operation is a correct answer, even an operator with limited experience in a loading operation can load the cargo 101 at a loading rate as high as that of a skillful operator. Thus, the loading rate of the cargo 101 can be improved.

Herein, the loading rate is at least one of a ratio of a volume occupied by the cargo 101 to the volume of the loading space, and a ratio of total weight of the cargo 101 loaded in the loading space to a predetermined upper limit of loading weight of the truck 102.

Further, for example, in machine learning of this type, a key factor (cargo information such as a size and weight) emphasized by a skillful operator for efficient loading and an item associated with a constraint condition may be decided in advance, based on a questionnaire survey, an item emphasized by an operator may be decided by inputting operation data to be reproduced with an operator skilled in a loading operation, and thus weights of each item may be decided. By deciding the loading position of the cargo 101a by using the learning model acquired by such machine learning, the cargo 101 can also be loaded at a loading rate as high as that of a skillful operator. Thus, the loading rate of the cargo 101 can be improved.

The output control unit 118 causes the monitor 110 to output the cargo specification information for specifying the cargo 101_a to be loaded next, which is decided in step S113 (step S115).

Specifically, for example, the output control unit 118 displays a current image of the transfer location 104 being captured by the first imaging unit 106, based on the first image data. The image includes an image of a current unloaded cargo 101_a. Further, for example, the output control unit 118 outputs, to the monitor 110, information for pointing the cargo 101_a decided in step S113, by a pointer having a predetermined shape such as an arrow. With this, the monitor 110 displays an image acquired by overlapping the image of the current unloaded cargo 101_a at the transfer location 104 with the image in which the cargo 101_a to be loaded next is pointed by the pointer, as the cargo specification information.

Note that, in the image, a method of pointing the cargo 101_a to be loaded next is not limited to the pointer, and various methods such as blinking light in a region of the cargo 101_a may be adopted.

The output control unit 118 causes the monitor 110 to output the position specification information for specifying the loading position decided in step S114 (step S116).

Specifically, for example, the output control unit 118 displays the current image of the loading space being captured by the second imaging unit 107, based on the second image data. The image indicates a current status of the loading space, and includes an image of the current unloaded cargo 101_b. Further, for example, the output control unit 118 outputs, to the monitor 110, information for pointing the loading position decided in step S114, by a pointer having a predetermined shape such as an arrow. With this, the monitor 110 displays an image acquired by overlapping the image of the current loaded cargo 101_b in the loading space with the image for pointing the loading position of the cargo 101_a to be loaded next, as the position specification information.

Note that, in the image, a method of pointing the loading position is not limited to the pointer, and various methods such as blinking light in a region associated with the size and the shape of the cargo 101_a to be loaded next may be adopted.

With this, the output control unit 118 terminates the loading assistance processing.

In the present example embodiment, when the cargo 101_n is added to the unloaded cargo group, the first acquiring unit 115 acquires the cargo information 114 relating to the cargo 101_n. With this, the first acquiring unit 115 acquires the cargo information 114 relating to each of the cargos 101_a included in the unloaded cargo group. Further, the second acquiring unit 116 acquires the loading information indicating a current loading status of the loading space.

Further, the cargo 101_a to be loaded next in the loading space is decided by using the cargo information and the loading information, and the cargo specification information for specifying the cargo 101_a to be loaded next is displayed on the monitor 110.

With this, an operator can easily and quickly discriminate the cargo 101_a to be loaded next in the loading space, by viewing the cargo specification information. Thus, efficiency of a loading operation of the cargo 101 can be improved.

Further, the cargo 101_a to be loaded next in the loading space is decided according to the current unloaded cargo 101_a and the current loading status of the loading space. Thus, for example, even an operator with relatively limited experience in a loading operation can load the cargo 101 at a high loading rate. Thus, the loading rate of the cargo 101 can be improved.

In the present example embodiment, the loading position of the cargo 101_a to be loaded next in the loading space is decided by using the cargo information and the loading information, and the position specification information for specifying the loading position of the cargo 101_a is displayed on the monitor 110.

With this, an operator can easily and quickly discriminate the loading position of the cargo 101a to be loaded next, by viewing the position specification information. Thus, efficiency of a loading operation of the cargo 101 can be improved.

Further, the loading position of the cargo 101a to be loaded next in the loading space is decided according to the current unloaded cargo 101_a and the current loading status of the loading space, and hence, for example, even an operator with relatively limited experience in a loading operation can load the cargo 101 at a high loading rate. Thus, the loading rate of the cargo 101 can be improved.

In the present example embodiment, the cargo information 114 includes at least one of the size, the weight, the shape, and the loading condition of each of the cargos 101_a. With this, the cargo 101_a to be loaded next in the loading space can be decided in such a way that the cargo 101 is loaded at a high loading rate. Further, the loading position of the cargo 101_a can be decided in such a way that the cargo 101 is loaded at a high loading rate. Thus, the loading rate of the cargo 101 can be improved.

In the present example embodiment, after the decision processing of steps S102, S107, and S108, step S113 is executed. Thus, when at least one of addition of the cargo 101_n to the unloaded cargo group and occurrence of a change of the current loading status of the loading space is detected, the cargo 101_a to be loaded next in the loading space is decided. Further, those changes are detected based on the first image data or the second image data that are acquired in real time.

With this, in a case in which a change occurs in any one of the cargo 101_n constituting the unloaded cargo group and the current loading status, when the change occurs, the cargo 101_a to be loaded next can be decided immediately. Thus, efficiency of a loading operation of the cargo 101 can be improved.

The first example embodiment of the present invention is described above. For example, the first example embodiment may be modified in various ways as in the following modification examples.

### First Modification Example: Modification Example of Configuration of Loading Assistance System

In the first example embodiment, description is made on an example in which one loading assistance apparatus 109 is connected to the cargo management apparatus 108. However, as in the first example embodiment, when the loading assistance apparatus 109 is provided in association with the transfer location 104 in each transport direction, the cargo management apparatus 108 may be connected to a plurality of the loading assistance apparatuses 109 associated with each of a plurality of transport directions, via the network N.

Further, the loading assistance apparatus 109 may also function as the cargo management apparatus 108. Moreover, one loading assistance apparatus 109 may be provided in association with the plurality of transport directions, and assist a loading operation at the transfer location 104 in each of the plurality of transport directions.

### Second Modification Example: Modification Example of First Output Unit and Second Output Unit

In the first example embodiment, description is made on an example in which the first output unit and the second output unit are achieved by one monitor 110. However, the first output unit and the second output unit may be achieved by different apparatuses from each other.

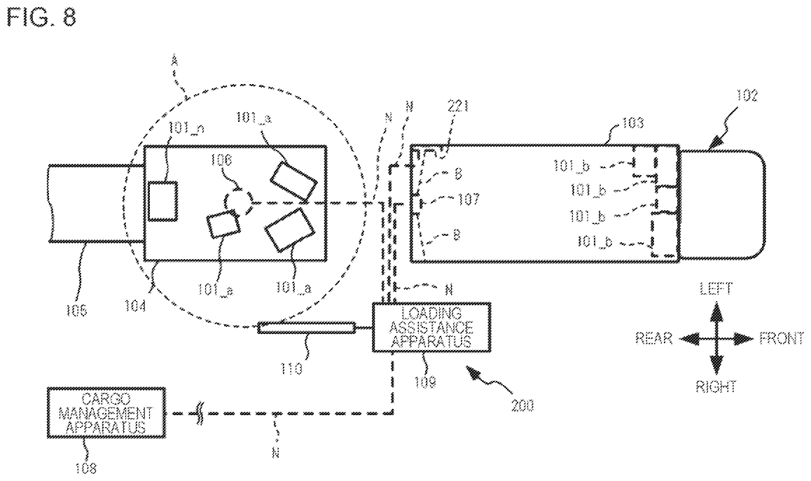

FIG. 8 is a diagram illustrating a configuration of a loading assistance system 200 according to a second modification example. The loading assistance system 200 includes a display apparatus 221 in addition to the first imaging unit 106, the second imaging unit 107, the cargo management apparatus 108, the loading assistance apparatus 109, and the monitor 110 similar to those in the first example embodiment.

The display apparatus 221 is connected to the loading assistance apparatus 109 in such a way as to be able to transmit and receive information mutually via the network N. Similarly to the monitor 110, the display apparatus 221 is an apparatus that displays an image under control of the output control unit 118, and may be provided in such a way as to allow an operator to browse at a time of performing a loading operation. FIG. 8 illustrates an example in which installation is performed inside the cargo bed 103, specifically, on a left inner wall of the cargo bed 103.

The monitor 110 according to the present example embodiment displays the cargo specification information. In other words, in the present example embodiment, the monitor 110 is equivalent to the first output unit that outputs the cargo specification information. The display apparatus 221 displays the position specification information. In other words, the display apparatus 221 is equivalent to the second output unit that outputs the position specification information.

For example, the display apparatus 221 described above may be a tablet terminal, a smartphone, or the like in a physical sense.

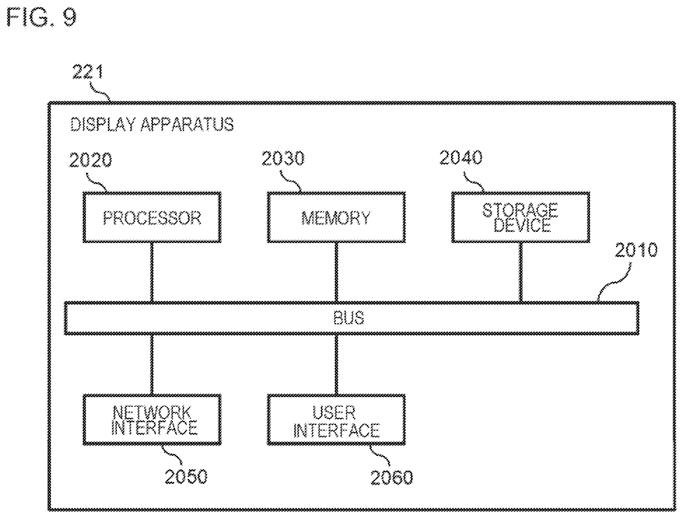

Specifically, for example, as illustrated in FIG. 9, the display apparatus 221 includes a bus 2010, a processor 2020, a memory 2030, a storage device 2040, a network interface 2050, and a user interface 2060 in a physical sense.

The bus 1010 is a data transmission path in which the processor 1020, the memory 1030, the storage device 1040, the network interface 1050, and the user interface 2060 transmit and receive data mutually. However, a method of connecting the processor 2020 and the like to one another is not limited to bus connection.

The processor 2020 is a processor achieved by a CPU, a GPU, or the like. The memory 2030 is a main storage apparatus achieved by a RAM, or the like. The storage device 2040 is an auxiliary storage apparatus achieved by an HDD, an SSD, a memory card, a ROM, or the like.

The storage device 2040 stores a program module for achieving a function of the display apparatus 221. The processor 2020 reads each of the program modules on the memory 1030 and executes the program module, and thereby the function associated with each of the program modules is achieved.

The network interface 2050 is an interface for connecting the display apparatus 221 to the network N.

The user interface 2060 is an interface for inputting information from a user, such as a touch panel, a keyboard, and a mouse, and is an interface for providing a user with information, such as a liquid crystal panel.

Note that, the display apparatus 221 may be a monitor similar to the monitor 110 in a physical sense. Further, similarly to the display apparatus 221, the monitor 110 may be a tablet terminal, a smartphone, or the like in a physical sense.

The present modification example also achieves an effect similar to that in the first example embodiment.

Moreover, according to the present modification example, the cargo specification information and the position specification information are output to the different apparatuses. With this, during an operation at the transfer location 104, an operator can view the monitor 110 that outputs the cargo specification information. Further, during an operation on the cargo bed 103 (the loading space), an operator can view the display apparatus 221 that outputs the position specification information.

In this manner, an operator can perform an operation while viewing a screen close to an operation location, and hence the cargo 101_a to be loaded next and the loading position thereof can be discriminated more easily and quickly. Thus, efficiency of a loading operation of the cargo 101 can further be improved.

In general, a loading operation is performed by a plurality of operators in some cases. For example, in some cases, a loading operation is performed while dividing the operation for a first operator who carries the cargo 101_a from the transfer location 104 to the cargo bed 103 and a second operator who arranges the cargo 101_a to the loading position on the cargo bed 103 (the loading space). In such a case, the first operator can perform a loading operation while viewing the monitor 110. Further, the second operator can perform a loading operation while viewing the display apparatus 221.

In this manner, when an operation is divided for a plurality of operators, the plurality of operators can perform the operation while viewing a screen close to each operation location, and hence the cargo 101_a to be loaded next and the loading position thereof can be discriminated more easily and quickly. Thus, efficiency of a loading operation of the cargo 101 can further be improved.

### Third Modification Example: Another Modification Example of First Output Unit and Second Output Unit

In the first example embodiment and the second modification example, description is made on an example in which the first output unit and the second output unit are apparatuses that display an image. A method of outputting the cargo specification information and the position specification information is not limited to display of an image. For example, the first output unit and the second output unit may be apparatuses that emit light, such as a laser pointer and a projector.

The loading assistance system according to the present modification example includes a first laser pointer as the first output unit, in place of the monitor 110 in the second modification example. Further, the loading assistance system according to the present modification example includes a second laser pointer as the second output unit, in place of the display apparatus 221 in the second modification example.

For example, the first laser pointer is provided in the vicinity of the first imaging unit 106 on the ceiling. The first laser pointer emits light to the cargo 101_a to be loaded next, under control of the output control unit 118. With this, the cargo specification information for specifying the cargo 101_a to be loaded next is output.

For example, the second laser pointer is provided in the vicinity of the second imaging unit 107 on the ceiling of the cargo bed 103. The second laser pointer emits light to the loading position of the cargo 101_a to be loaded next, under control of the output control unit 118. With this, the position specification information for specifying the loading position of the cargo 101a to be loaded next is output.

The present modification example also achieves an effect similar to that in the first example embodiment.

Moreover, according to the present modification example, the cargo 101_a to be loaded next is specified by light emitted to the cargo 101a. Thus, an operator can immediately discriminate the cargo 101_a to be loaded next by viewing the cargo 101_a at the transfer location 104, without browsing the monitor 110 or the like. In other words, an operator can discriminate the cargo 101_a to be loaded next more easily and quickly. Thus, efficiency of a loading operation of the cargo 101 can further be improved.

Moreover, according to the present modification example, the loading position of the cargo 101a to be loaded next is specified by light emitted to the loading position, and hence an operator can immediately discriminate the loading position of the cargo 101_a to be loaded next by viewing the inside of the cargo bed 103 (the loading space), without browsing the monitor 110 or the like. In other words, an operator can discriminate the loading position more easily and quickly. Thus, efficiency of a loading operation of the cargo 101 can further be improved.

### Fourth Modification Example: Modification Example in which Loaded Cargo 101_b is Set to Target Cargo to be Loaded Next

In the first example embodiment, description is made on an example in which the cargo 101 to be loaded next, which is decided by the deciding unit 117, is decided from the unloaded cargo 101_a.

However, in some cases, the loading rate can be improved by relocating the loading position of the loaded cargo 101_b. In the present modification example, description is made on an example in which the cargo 101 to be loaded next, which is decided by the deciding unit 117, is decided not only from the unloaded cargo 101_a but also from the loaded cargo 101_b.

Herein, when the loading position of the loaded cargo 101_b is relocated, work efficiency may actually be degraded by relocating the loading position of the cargo 101_b being loaded on a far side, for example. Thus, when relocating the loading position of the cargo 101_b, it is desired to relocate the cargo 101_b being relatively easy to relocate.

Examples of the cargo 101_b being relatively easy to relocate may include the cargo 101_b exposed to an outside in the loading space (in other words, the cargo 101_b loaded on a front side), particularly, the cargo 101_b of such cargo being loaded on an upper side (alternatively, on a top tier), and the like. In this manner, the cargo 101_b being loaded within a predetermined range in the current loading status of the loading space may be the cargo 101 being a target to be loaded next.

Among the cargo 101_bs loaded in the loading space, the cargo 101_b loaded within the predetermined range being a range that relatively facilitates relocation is collectively referred to as a term “provisional loaded cargo group”.

The first acquiring unit 115 according to the present modification example acquires the cargo information 114 relating to each of the plurality of the cargos 101_a included in the unloaded cargo group. In addition, the first acquiring unit 115 according to the present modification example acquires the cargo information 114 relating to each of the cargos 101_b included in the provisional loaded cargo group.

For the first acquiring unit 115 according to the present modification example, the matter that the cargo information 114 relating to the cargo 101_a is acquired is also similar to the first acquiring unit 115 according to the first example embodiment. Thus, description for details regarding acquisition of the cargo information 114 relating to the cargo 101a is omitted.

The first acquiring unit 115 according to the present modification example acquires second image data from the second imaging unit 107 in real time. From the loaded cargo 101b, the first acquiring unit 115 determines an image of each of the cargos 101_b included in the provisional loaded cargo group, based on the second image data. The first acquiring unit 115 acquires the cargo information 114 relating to each of the cargos 101_b included in the provisional loaded cargo group, which is determined based on the second image data, by communicating with the cargo management apparatus 108, and stores the acquired cargo information 114.

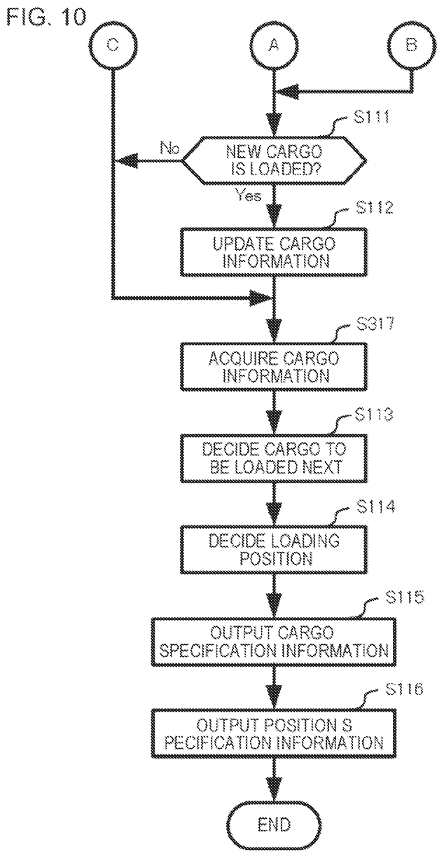

In the present modification example, the processing from steps S101 to S112 similar to that in the first example embodiment is executed. Further, in the present modification example, as illustrated in FIG. 10, processing in step S317 is executed before step S113. In step S317, the first acquiring unit 115 acquires the cargo information 114 relating to each of the cargos 101_b included in the provisional loaded cargo group.

Appropriate methods may be adopted as a method of acquiring the cargo information 114 in step S317. Herein, as examples, fourth to sixth methods of acquiring the cargo information 114 are described below.

### (Fourth Method of Acquiring Cargo Information 114)

The first acquiring unit 115 acquires, from the cargo management apparatus 108, the cargo information 114 associated with the cargo 101_b included in the provisional loaded cargo group, based on the second image data.

Specifically, for example, the first acquiring unit 115 determines a shape and a size of the cargo 101b included in the provisional loaded cargo group from the second image data. A related-art technique may be adopted to determine the shape and the size of the cargo 101_b from the second image data. The first acquiring unit 115 transmits an inquiry including the shape and the size that are determined, to the cargo management apparatus 108.

Similarly to the first method of acquiring the cargo information 114, the storage control unit 113 executes the extraction processing and the determination processing of the cargo information 114.

However, the cargo 101_n in the first method of acquiring the cargo information 114 is the cargo 101_b included in the provisional loaded cargo group in the fourth method of acquiring the cargo information 114. Further, a condition of the “current status” being applied to extract the cargo information 114 relating to the cargo 101_b included in the provisional loaded cargo group is “loaded”.

Further, the storage control unit 113 transmits the determined cargo information 114 to the loading assistance apparatus 109. With this, the first acquiring unit 115 acquires the cargo information 114 relating to the cargo 101_b included in the provisional loaded cargo group.

### (Fifth Method of Acquiring Cargo Information 114)

Similarly to the second method of acquiring the cargo information 114, the first acquiring unit 115 may acquire the cargo information 114 from the cargo management apparatus 108, and execute the extraction processing and the determination processing of the cargo information 114 relating to the cargo 101_b included in the provisional loaded cargo group. Alternatively, the first acquiring unit 115 may acquire, from the cargo management apparatus 108, the cargo information 114 extracted by the extraction processing of the cargo information 114 relating to the cargo 101_b included in the provisional loaded cargo group, and execute the determination processing of the cargo information 114 relating to the cargo 101_b.

### (Sixth Method of Acquiring Cargo Information 114)

Similarly to the third method of acquiring the cargo information 114, the first acquiring unit 115 may acquire the cargo information 114 relating to the cargo 101_b included in the provisional loaded cargo group, by generating the cargo information 114 relating to the cargo 101_b included in the provisional loaded cargo group, based on the second image data.

A method of acquiring information to be set for each element constituting the cargo information 114 by the first acquiring unit 115 is similar to the third method of acquiring the cargo information 114.

However, first image data in the third method of acquiring the cargo information 114 is the second image data in the sixth method of acquiring the cargo information 114. Further, the cargo 101_n in the third method of acquiring the cargo information 114 is the cargo 101_b included in the provisional loaded cargo group in the sixths method of acquiring the cargo information 114.

When the first acquiring unit 115 acquires information to be set for each element constituting the cargo information 114, based on the second image data, each piece of the acquired information is associated with each other. With this, the first acquiring unit 115 can generate the cargo information 114 relating to the cargo 101_b included in the provisional loaded cargo group.

In step S113 according to the present modification example, the deciding unit 117 decides the cargo 101 to be loaded next onto the cargo bed 103 (the loading space), based on the cargo information 114 relating to the unloaded cargo 101_a and the cargo 101_b included in the provisional loaded cargo group, and the loading information acquired in step S106.

In step S114 according to the present modification example, similarly to the first example embodiment, the deciding unit 117 decides the loading position of the cargo 101 decided in step S113.

In step S115 according to the present modification example, the output control unit 118 causes the monitor 110 to output the cargo specification information for specifying the cargo 101 to be loaded next, which is decided in step S113.

Specifically, for example, when the cargo 101 to be loaded next is the unloaded cargo 101_a, the output control unit 118 may execute processing similar to that in the first example embodiment.

When the cargo 101 to be loaded next is any of the cargos 101_b included in the provisional loaded cargo group, the output control unit 118 according to the present modification example displays a current image of the loading space being captured by the second imaging unit 107, based on the second image data. Further, for example, the output control unit 118 outputs, to the monitor 110, information for pointing the cargo 101 decided in step S113, by a pointer having a predetermined shape such as an arrow. With this, the monitor 110 displays an image acquired by overlapping an image of the current loaded cargo 101_b in the loading space with an image in which the cargo 101_b, which is decided as the cargo 101 to be loaded next, is pointed by the pointer, as the cargo specification information.

In step S116 according to the present modification example, similarly to the first example embodiment, the output control unit 118 causes the monitor 110 to output the position specification information for specifying the loading position decided in step S114.

The present modification example also achieves an effect similar to that in the first example embodiment.

Moreover, according to the present modification example, the loaded cargo 101_b is included as the cargo 101 being a target to be loaded next in the provisional loaded cargo group. With this, the loading rate of the cargo 101 can be improved.

Further, among the loaded cargos 101_b, the cargo 101_b included in the provisional loaded cargo group is the cargo 101_b loaded within the predetermined range that relatively facilitates relocation. With this, degradation of efficiency of a loading operation due to relocation of the loaded cargo 101_b can be suppressed.

Thus, the loading rate of the cargo 101 can further be improved while suppressing degradation of efficiency of a loading operation.

### Second Example Embodiment

In the first example embodiment, description is made on an example in which the cargo 101 to be loaded next, which is decided by the deciding unit 117, is decided from all of the unloaded cargo 101_a.

However, it is desired that some of the cargos 101a is loaded onto the cargo bed 103 (the loading space) at predetermined timing, that is, is loaded onto the cargo bed 103 last, for example. Examples of the cargo 101a of this type include the cargo 101a that has a distinctive shape such as a golf bag or needs to be handled with care, such as a fragile item and delicate machinery.

In a second example embodiment, description is made on an example in which a cargo 101_a satisfying a predetermined reservation condition is handled as a reserved cargo and is loaded onto a cargo bed 103 (a loading space) at predetermined timing. In the present example embodiment, a different point from the first example embodiment is mainly described, and a similar point to the first example embodiment is omitted as appropriate for clarity of description.

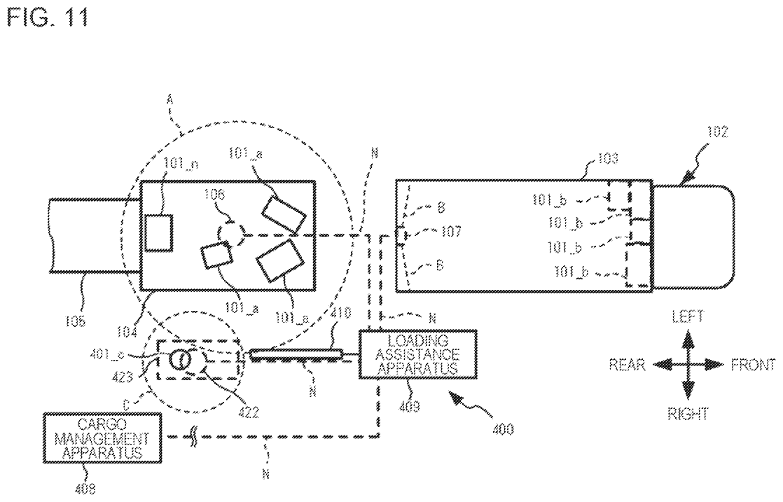

As illustrated in FIG. 11, a loading assistance system 400 according to the second example embodiment of the present invention includes a first imaging unit 106 and a second imaging unit 107 similar to those in the first example embodiment. Further, the loading assistance system 400 includes a cargo management apparatus 408, a loading assistance apparatus 409, and a monitor 410, in place of the cargo management apparatus 108, the loading assistance apparatus 109, and the monitor 110 according to the first example embodiment, respectively. Moreover, the loading assistance system 400 includes a third imaging unit 422.

Each of the first imaging unit 106, the second imaging unit 107, the third imaging unit 422, and the cargo management apparatus 408 is connected to the loading assistance apparatus 409 in such a way as to be able to transmit and receive information mutually with the loading assistance apparatus 409 via a network N.

The third imaging unit 422 captures an image of a reservation location 423, and generates third image data including the captured image.

The reservation location 423 is a region to which a reserved cargo 401_c is relocated from a transfer location 104 for reservation until loading timing. The reservation location 423 is provided in a vicinity of the transfer location 104 (in FIG. 11, a left side of the transfer location 104).

The reserved cargo 401_c is the unloaded cargo 101_a satisfying a predetermined reservation condition.

As the reservation condition, a cargo of a specific type such as a golf bag, a specific loading condition such as a fragile item and delicate machinery, or the like is set in advance as appropriate.

The loading timing is set in advance as timing at which the reserved cargo 401_c is loaded. Examples of the loading timing may include timing “after a loading status (e.g., a spatial loading rate) of the cargo bed 103 satisfies a criteria”. The loading timing may be set for each reservation condition. Condition information relating to reservation in which the reservation condition and the loading timing are associated with each other may be stored in, for example, a deciding unit 417, which is described later, in advance.

As illustrated in FIG. 11, the third imaging unit 422 according to the present example embodiment is installed on a ceiling directly above substantially the center of the reservation location 423, and captures an image of a region surrounded by a dot-line circle C illustrated in FIG. 11. With this, the third imaging unit 422 captures an image of the enter reservation location 423, and generates the third image data including an image of the reserved cargo 401_c reserved at the reservation location 423.

Note that, when an imaging region of a first imaging unit 106 includes the reservation location 423, the third imaging unit 422 is not required to be included in the loading assistance system 400.

### (Functional Configuration of the Cargo Management Apparatus 408)

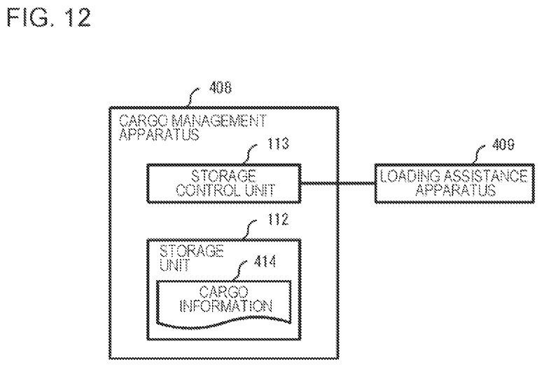

As illustrated in FIG. 12, the cargo management apparatus 408 includes a storage unit 112 and a storage control unit 113 similar to those in the first example embodiment in a functional sense. In the present example embodiment, a configuration of cargo information 414 stored in the storage unit 112 is different from that in the first example embodiment.

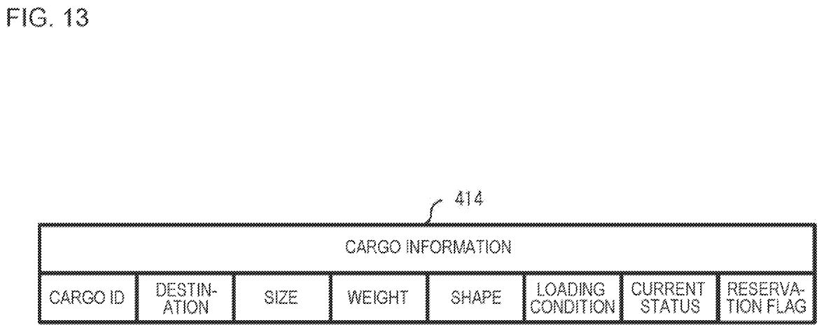

The cargo information 414 is information relating to a cargo 101, and a “reservation flag” is further associated therewith in addition to information constituting the cargo information 114 according to the first example embodiment, as illustrated in FIG. 13, for example.

The “reservation flag” is information indicating whether the cargo 101 identified by a cargo ID being associated therewith is the reserved cargo 401_c. For example, “1” is set to the “reservation flag” of the reserved cargo 401_c, and “0” is set to the “reservation flag” of the unloaded cargo 101a other than the reserved cargo 401_c.

Note that, the information to be set to the “reservation flag” is not limited to “0” or “1”, and a numeral, a character, or the like may be set as appropriate in association with whether to indicate the reserved cargo 401_c.

### (Functional Configuration of Loading Assistance Apparatus 409)

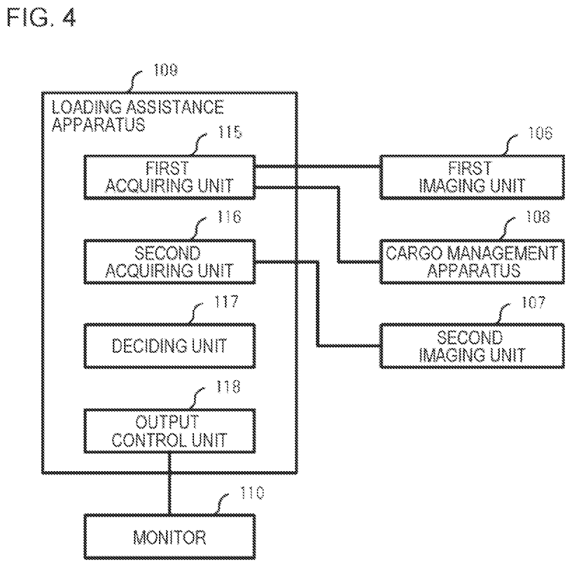

As illustrated in FIG. 4, in a functional sense, the loading assistance apparatus 409 includes a first acquiring unit 115 and a second acquiring unit 116, which are similar to those in the first example embodiment, and the deciding unit 417 and an output control unit 418 in place of the deciding unit 117 and the output control unit 118 according to the first example embodiment, respectively.

Similarly to the first example embodiment, the deciding unit 417 decides a cargo 101_a to be loaded next in the loading space and a loading position of the cargo 101_a, by using the cargo information and loading information.

When an unloaded cargo 101_n is added to an unloaded cargo group, the deciding unit 417 according to the present example embodiment further decides whether the added cargo 101_n is a reserved cargo satisfying the predetermined reservation condition. The decision is made by using the cargo information relating to the added cargo 101_n.

When the reserved cargo 401_c is at the reservation location 423, the deciding unit 417 according to the present example embodiment further decides whether the reserved cargo 401_c satisfies the predetermined loading timing. The decision is made by using the cargo information 414 relating to the reserved cargo 401_c and the loading information.

Similarly to the first example embodiment, the output control unit 418 causes the monitor 410 to output cargo specification information and position specification information.

When it is decided that the cargo 101_n being added to the unloaded cargo group is the reserved cargo 401_c, the output control unit 418 according to the present example embodiment further causes the monitor 410 to display reservation specification information. The reservation specification information is information for specifying the cargo 101_c, which is added to the unloaded cargo group, as the reserved cargo.

When it is decided that the reserved cargo 401c satisfies the loading timing, the output control unit 418 according to the present example embodiment further causes the monitor 410 to display the cargo specification information. The cargo specification information being output herein is information for specifying the reserved cargo 401_c as the cargo to be loaded next.

Refer back to FIG. 11.

Similarly to the first example embodiment, the monitor 410 displays the cargo specification information and the position specification information under control of the output control unit 418. In other words, similarly to the first example embodiment, the monitor 410 according to the present example embodiment is equivalent to a first output unit and a second output unit.

Under control of the output control unit 418, the monitor 410 according to the present example embodiment further displays the reservation specification information for specifying the cargo 101_c being added to the unloaded cargo group as the reserved cargo. In other words, the monitor 410 according to the present example embodiment is equivalent to a third output unit that outputs the reservation specification information for specifying the cargo 101_c being added to the unloaded cargo group as the reserved cargo.

Under control of the output control unit 418, the monitor 410 according to the present example embodiment further displays the cargo specification information for specifying the reserved cargo 401_c as the cargo to be loaded next. In other words, the monitor 410 according to the present example embodiment is equivalent to a fourth output unit that outputs the cargo specification information for specifying the reserved cargo 401_c as the cargo to be loaded next.

In this manner, In the present example embodiment, the first output unit, the second output unit, the third output unit, and the fourth output unit are achieved by one monitor 410. For example, the cargo specification information, the position specification information relating to the cargo 101_a at the transfer location 104, the reservation specification information, and the position specification information relating to the reserved cargo 401_c may be displayed separately in different regions acquired by dividing a display region of the monitor 410, or may be displayed sequentially at a predetermined time interval on the monitor 410.

Note that, as described in the second modification example, some or all the first output unit, the second output unit, the third output unit, and the fourth output unit may be different apparatuses from one another. Further, as described in the third modification example, an apparatus for achieving some or all the first output unit, the second output unit, the third output unit, and the fourth output unit may be an apparatus that emits light, such as a laser pointer and a projector.

The functional configuration of the loading assistance system 400 according to the second example embodiment is described above. A physical configuration of the loading assistance system 400 is described below.

Each of the first imaging unit 106 and the second imaging unit 107 may be configured similarly to the first example embodiment in a physical sense. Similarly to each of the first imaging unit 106 and the second imaging unit 107, the third imaging unit 422 is achieved by a camera including an imaging element, for example. The third imaging unit 422 is preferably a 3D camera capable of also acquiring information (depth upward) relating to a depth direction. An imaging method of the 3D camera may adopt a related-art technique.

The cargo management apparatus 408, the loading assistance apparatus 409, and the monitor 410 may be configured similarly to the cargo management apparatus 108, the loading assistance apparatus 109, and the monitor 110 according to the first example embodiment, respectively, in a physical sense.

The configuration of the loading assistance system 400 according to the second example embodiment of the present invention is described above. An operation of the loading assistance system 400 according to the present example embodiment is described below.

### <Operation of Loading Assistance System 400>

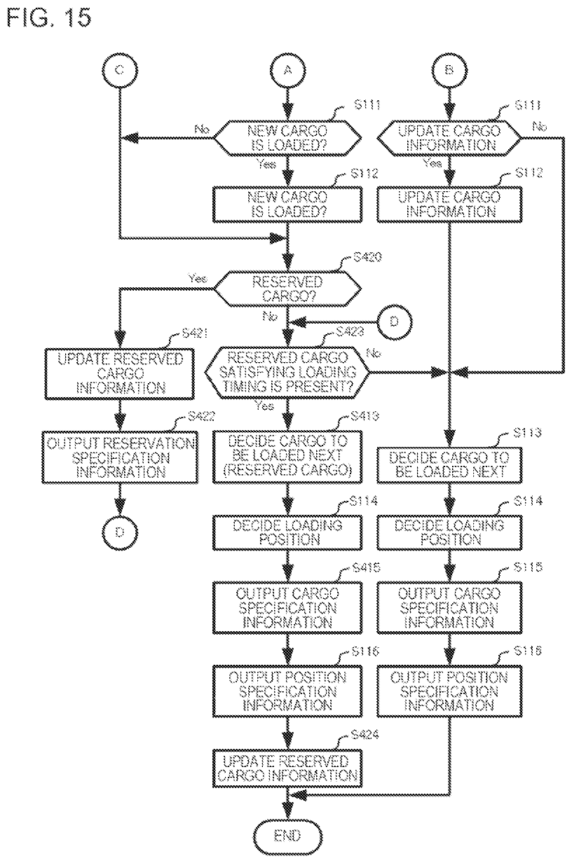

In the present example embodiment, processing from steps S101 to S108 similar to that in the first example embodiment is also executed (see FIG. 6). In loading assistance processing according to the present example embodiment, processing illustrated in FIG. 15 is executed after the processing from steps S101 to S108.

For example, when the first imaging unit 106, the second imaging unit 107, the third imaging unit 422, the cargo management apparatus 408, the loading assistance apparatus 409, and the monitor 410 are operated, the loading assistance processing is started, and is executed repeatedly during the operations of these, which is similar to the first example embodiment.

In the present example embodiment, similarly to each of the first imaging unit 106 and the second imaging unit 107, the third imaging unit 422 continuously outputs the third image data during the operation. With this, the loading assistance apparatus 409 can acquire the third image data indicating a current status of the reservation location 423, in addition to the first image data and the second image data, in real time.

Refer to FIG. 6.

In the loading assistance processing according to the present example embodiment, after step S101 similar to that in the first example embodiment, when it is decided that there is not the added cargo 101_n (step S102; No), processing in steps S105, S106, and S108 similar to that in the first example embodiment is executed. After that, as illustrated in FIG. 16, processing from steps S111 to S116 similar to that in the first example embodiment is executed.

Further, as illustrated in FIG. 6 and FIG. 16, when it is decided that there is the added cargo 101_n (step S102; Yes), processing in steps S103 to S107, S111, and S112 similar to that in the first example embodiment is executed. After that, in the loading assistance processing according to the present example embodiment, the deciding unit 417 decides whether the cargo 101_n is a reserved cargo satisfying the predetermined reservation condition, based on the cargo information 414 relating to the added cargo 101_n, which is acquired in step S103 (step S420).

When it is decided that the reserved cargo is present (step S420; Yes), the deciding unit 417 stores the cargo information 414 acquired in step S103, and also transmits an instruction of setting “1” to the “reservation flag” in the cargo information 414 to the cargo management apparatus 108. With this, the deciding unit 417 updates reserved cargo information relating to the reserved cargo 401c (step S421).

Specifically, for example, the deciding unit 417 can store the cargo information 414 relating to the reserved cargo 401_c as the reserved cargo information, by storing the cargo information 414 acquired in step S103. Further, the deciding unit 417 transmits an instruction of setting the above-mentioned instruction to the cargo management apparatus 108, and thus “1” being set in advance as the information indicating the reserved cargo is set to the “reservation flag” in the cargo information 414 relating to the reserved cargo 401_c stored in the storage unit 112.

The output control unit 418 causes the monitor 410 to output the reservation specification information for specifying the cargo 101_c being added to the unloaded cargo group as the reserved cargo (step S422).

Specifically, for example, the output control unit 418 displays a current image of the transfer location 104 being captured by the first imaging unit 106, based on the first image data. The image includes an image of the current unloaded cargo 101_a. Further, for example, the output control unit 418 outputs, to the monitor 410, information for pointing the cargo 101_c decided to be the reserved cargo in step S420, by a pointer having a predetermined shape such as an arrow. With this, the monitor 410 displays an image acquired by overlapping the image of the current unloaded cargo 101_a at the transfer location 104 with the image in which the cargo 101_c decided as the reserved cargo is pointed by the pointer, as the reservation specification information.

An operator who views the reservation specification information on the monitor 410 relocates the reserved cargo 401c specified by the reservation specification information, to the reservation location 423. With this, the reserved cargo 401_c is reserved at the reservation location 423.

When it is decided that the reserved cargo is present (step S420; Yes), or after the processing in step S422, the deciding unit 417 decides whether the reserved cargo 401_c satisfying the loading timing is at the reservation location 423 (step S423).

Specifically, for example, the deciding unit 417 acquires the third image data from the third imaging unit 422. The deciding unit 417 decides whether the reserved cargo 401_c is at the reservation location 423, based on the third image data. When the reserved cargo 401_c is not at the reservation location 423, the deciding unit 417 decides that the reserved cargo 401_c satisfying the loading timing is not at the reservation location 423.

When the reserved cargo 401_c is at the reservation location 423, the deciding unit 417 refers to the cargo information 414 relating to a placed cargo 101_c, which is stored in the own unit. The deciding unit 417 determines the reservation condition of the reserved cargo 401_c, based on the cargo information 414 relating to the reserved cargo 401_c and the condition information relating to reservation, and acquires the loading timing associated with the determined reservation condition. The deciding unit 417 decides whether the reserved cargo 401_c satisfies the loading timing, based on the acquired loading timing and the loading information.

For example, when the loading timing is “after the spatial loading rate of the cargo bed 103 satisfies the criteria”, the deciding unit 417 acquires a ratio (spatial loading rate) of a volume occupied by the cargo 101 to a volume of the loading space, based on the second image data.

Further, when the spatial loading rate satisfies the criteria, the deciding unit 417 decides that the reserved cargo 401_c satisfies the loading timing. In other words, the deciding unit 417 decides that the reserved cargo 401_c satisfying the loading timing is at the reservation location 423.

Further, when the spatial loading rate does not satisfy the criteria, the deciding unit 417 decides that the reserved cargo 401_c does not satisfy the loading timing. In other words, the deciding unit 417 decides that the reserved cargo 401_c satisfying the loading timing is not at the reservation location 423.

When it is decided that the reserved cargo 401_c satisfying the loading timing is not at the reservation location 423 (step S423; No), the processing from steps S113 to S116 similar to that in the first example embodiment is executed.

When it is decided that the reserved cargo 401c satisfying the loading timing is at the reservation location 423 (step S423; Yes), the deciding unit 417 decides the reserved cargo 401_c satisfying the loading timing as the cargo 101_a to be loaded next (step S413).

Similarly to the first example embodiment, the deciding unit 417 decides the loading position of the reserved cargo 401_c decided in step S413 (step S114).

The output control unit 418 causes the monitor 410 to output the cargo specification information for specifying the reserved cargo 401_c to be loaded next, which is decided in step S413 (step S415).

Specifically, for example, the output control unit 418 displays a current image of the reservation location 423 being captured by the third imaging unit 422, based on the third image data. The image includes an image of the reserved cargo 401_c. Further, for example, the output control unit 418 outputs, to the monitor 410, information for pointing the reserved cargo 401_c decided in step S413, by a pointer having a predetermined shape such as an arrow. With this, the monitor 410 displays an image acquired by overlapping the image of the current reserved cargo 401c at the reservation location 423 with the image in which the reserved cargo 401_c to be loaded next is pointed by the pointer, as the cargo specification information.

Similarly to the first example embodiment, the output control unit 118 causes the monitor 410 to output the position specification information for specifying the loading position decided in step S114 (step S116).

The deciding unit 417 removes the cargo information 414 relating to the reserved cargo 401c being decided to satisfy the loading timing in step S423, from the cargo information 414 stored as the reserved cargo information in the own unit. Further, the deciding unit 417 transmits an instruction of setting “0” to the “reservation flag” in the cargo information 414 relating to the reserved cargo 401_c, to the cargo management apparatus 108. With this, the deciding unit 417 updates the reserved cargo information relating to the reserved cargo 401_c (step S424).

Specifically, for example, the deciding unit 417 removes the cargo information 414 stores as the reserved cargo information in the own unit, and thus stores the current cargo information 414 relating to the reserved cargo 401_c as the reserved cargo information. Further, the deciding unit 417 transmits an instruction of setting the above-mentioned instruction to the cargo management apparatus 108, and thus “0” being set in advance as the information indicating that the cargo is not the reserved cargo is set to the “reservation flag” in the cargo information 414 relating to the reserved cargo 401_c stored in the storage unit 112.

With this, the deciding unit 417 terminates the loading assistance processing.

In the present example embodiment, when the cargo 101_c is added to the unloaded cargo group, the cargo information relating to the added cargo 101_c is acquired. Further, it is decided whether the added cargo 101_c is the reserved cargo satisfying the reservation condition, by using the cargo information 414 relating to the added cargo 101_c.

With this, when the cargo 101_c is added to the unloaded cargo group, it can be decided whether the cargo 101_c is the reserved cargo. Thus, the cargo 101_c can be handled as the reserved cargo different from another unloaded cargo 101_a in a point that the cargo 101_c is not loaded until the loading timing, and hence efficiency of a loading operation can be improved. Thus, efficiency of a loading operation of the cargo 101 can be improved.

In the present example embodiment, when it is decided that the added cargo 101_c is the reserved cargo, the reservation specification information for specifying the added cargo 101_c as the reserved cargo is output. With this, the reserved cargo 401_c not being loaded until the loading timing can be discriminated easily and quickly, and can be relocated from the transfer location 104.

When a large volume of the cargo 101a is carried to the transfer location 104, density of the cargo 101_a at the transfer location 104 is high, and efficiency of a loading operation of the cargo 101 may be degraded. According to the present example embodiment, as described above, the reserved cargo 401_c can be relocated from the transfer location 104, and hence the volume of the cargo 101_a at the transfer location 104 can be reduced, and degradation of efficiency of a loading operation of the cargo 101 can be suppressed. Thus, efficiency of a loading operation of the cargo 101 can be improved.

According to the present example embodiment, when it is decided that the reserved cargo 401_c satisfies the loading timing, the cargo specification information for specifying the reserved cargo 401_c as the cargo to be loaded next is output. With this, an operator can securely load the reserved cargo 401_c onto the cargo bed 103 (the loading space) at the loading timing of the reserved cargo 401_c. By handling the reserved cargo 401_c appropriately as described above, damage of the reserved cargo 401_c can be prevented, and the loading rate of the cargo 101 can be improved.

With reference to the drawings, the example embodiments and the modification examples of the present invention are described above, but those are merely examples of the present invention, and various configurations other than those described above may be adopted.

Further, in the plurality of flowcharts used in the description given above, the plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments and the modification examples described above may be combined with each other within a range where the contents do not conflict with each other.

The whole or a part of the example embodiments described above can be described as, but not limited to, the following supplementary notes.

1.

A loading assistance apparatus including:
a first acquiring unit that acquires cargo information relating to each of cargos included in an unloaded cargo group;
a second acquiring unit that acquires loading information indicating a current loading status of a loading space;
a deciding unit that decides a cargo to be loaded next in the loading space, by using the cargo information and the loading information; and
an output control unit that causes a first output unit to output cargo specification information for specifying the cargo to be loaded next.
   2.

The loading assistance apparatus according to supplementary note 1, wherein
the deciding unit further decides a loading position of the cargo to be loaded next in the loading space, by using the cargo information and the loading information, and
the output control unit further causes a second output unit to output position specification information for specifying the loading position of the cargo to be loaded next.
   3.

The loading assistance apparatus according to supplementary note 1 or 2, wherein
the cargo information includes at least one of a size, weight, a shape, and a loading condition of each of the cargos.
   4.

The loading assistance apparatus according to any one of supplementary notes 1 to 3, wherein,
when a cargo is added to the unloaded cargo group, the first acquiring unit acquires cargo information relating to the added cargo, and
the deciding unit further decides whether the added cargo is a reserved cargo satisfying a predetermined reservation condition, by using the cargo information relating to the added cargo.
   5.

The loading assistance apparatus according to supplementary note 4, wherein,
when it is decided that the added cargo is the reserved cargo, the output control unit further causes a third output unit to output reservation specification information for specifying the added cargo as a reserved cargo.
   6.

The loading assistance apparatus according to supplementary note 5, wherein
the deciding unit further decides whether the reserved cargo satisfies predetermined loading timing, by using the cargo information and the loading information, and,
when it is decided that the reserved cargo satisfies loading timing, the output control unit causes a fourth output unit to output the cargo specification information for specifying the reserved cargo as the cargo to be loaded next.
   7.

The loading assistance apparatus according to any one of supplementary notes 1 to 6, wherein,
when at least one of addition of a cargo to the unloaded cargo group and occurrence of a change of a current loading status of the loading space is detected, the deciding unit decides a cargo to be loaded next in the loading space, by using the cargo information and the loading information.
   8.

The loading assistance apparatus according to any one of supplementary notes 1 to 7, wherein,
among cargos loaded in the loading space, the first acquiring unit acquires cargo information relating to each of one or a plurality of cargos included in a provisional loaded cargo group loaded within a predetermined range.
   9.

A loading assistance system including:
a first acquiring unit that acquires cargo information relating to each of cargos included in an unloaded cargo group;
a second acquiring unit that acquires loading information indicating a current loading status of a loading space;
a deciding unit that decides a cargo to be loaded next in the loading space, by using the cargo information and the loading information; and
a first output unit that outputs cargo specification information for specifying the cargo to be loaded next.
   10.

A loading assistance method including:
acquiring cargo information relating to each of cargos included in an unloaded cargo group;
acquiring loading information indicating a current loading status of a loading space;
deciding a cargo to be loaded next in the loading space, by using the cargo information and the loading information; and
causing a first output unit to output cargo specification information for specifying the cargo to be loaded next.
   11.

A program for causing a computer to execute:
acquiring cargo information relating to each of cargos included in an unloaded cargo group;
acquiring loading information indicating a current loading status of a loading space;
deciding a cargo to be loaded next in the loading space, by using the cargo information and the loading information; and
causing a first output unit to output cargo specification information for specifying the cargo to be loaded next.

### REFERENCE SIGNS LIST

100, 200, 400 Loading assistance system
101, 101_a, 101_b, 101_n Cargo
102 Truck
103 Cargo bed
104 Transfer location
105 Conveyor
106 First imaging unit
107 Second imaging unit
108, 408 Cargo management apparatus
109, 409 Loading assistance apparatus
110, 410 Monitor
112 Storage unit
113 Storage control unit
114, 414 Cargo information
115 First acquiring unit
116 Second acquiring unit
117, 417 Deciding unit
118, 418 Output control unit
221 Display apparatus
401_c Reserved cargo
422 Third imaging unit
423 Reservation location

What is claimed is:

1. A loading assistance apparatus comprising:
at least one memory configured to store instructions; and
at least one processor configured to execute the instructions to:
acquire cargo information relating to each of cargos included in an unloaded cargo group;
acquire loading information indicating a current loading status of a loading space;
decide a cargo to be loaded next in the loading space, by using the cargo information and the loading information; and
cause a first output unit to output cargo specification information for specifying the cargo to be loaded next.

2. The loading assistance apparatus according to claim 1,
the at least one processor configured further to execute the instructions to:
decide a loading position of the cargo to be loaded next in the loading space, by using the cargo information and the loading information, and
cause a second output unit to output position specification information for specifying the loading position of the cargo to be loaded next.

3. The loading assistance apparatus according to claim 1, wherein
the cargo information includes at least one of a size, weight, a shape, and a loading condition of each of the cargos.

4. The loading assistance apparatus according to claim 1,
the at least one processor configured further to execute the instructions to: when a cargo is added to the unloaded cargo group, acquire cargo information relating to the added cargo, and
decide whether the added cargo is a reserved cargo satisfying a predetermined reservation condition, by using the cargo information relating to the added cargo.

5. The loading assistance apparatus according to claim 4,
the at least one processor configured further to execute the instructions to:
when it is decided that the added cargo is the reserved cargo, cause a third output unit to output reservation specification information for specifying the added cargo as a reserved cargo.

6. The loading assistance apparatus according to claim 5,
the at least one processor configured further to execute the instructions to:
decide whether the reserved cargo satisfies predetermined loading timing, by using the cargo information and the loading information, and,
when it is decided that the reserved cargo satisfies loading timing, cause a fourth output unit to output the cargo specification information for specifying the reserved cargo as the cargo to be loaded next.

7. The loading assistance apparatus according to claim 1, wherein,
the decision of the cargo to be loaded next in the loading space is executed when at least one of addition of a cargo to the unloaded cargo group and occurrence of a change of a current loading status of the loading space is detected.

8. The loading assistance apparatus according to claim 1,
the at least one processor configured further to execute the instructions to:
acquire, among cargos loaded in the loading space, cargo information relating to each of one or a plurality of cargos included in a provisional loaded cargo group loaded within a predetermined range.

9. (canceled)

10. A loading assistance method comprising:
acquiring cargo information relating to each of cargos included in an unloaded cargo group;
acquiring loading information indicating a current loading status of a loading space;
deciding a cargo to be loaded next in the loading space, by using the cargo information and the loading information; and
causing a first output unit to output cargo specification information for specifying the cargo to be loaded next.

11. A non-transitory storage medium storing a program for causing at least one computer to execute:
acquiring cargo information relating to each of cargos included in an unloaded cargo group;
acquiring loading information indicating a current loading status of a loading space;
deciding a cargo to be loaded next in the loading space, by using the cargo information and the loading information; and
causing a first output unit to output cargo specification information for specifying the cargo to be loaded next.
